(19) United States
(12) Patent Application Publication
(10) Pub. No.: US 2026/0152104 A1
(43) Pub. Date: Jun. 4, 2026

(54) ARMREST ARRANGEMENT FOR A VEHICLE SEAT, AND VEHICLE SEAT WITH SUCH AN ARMREST ARRANGEMENT

(71) Applicant: BOS GmbH & Co. KG, Ostfildern (DE)

(72) Inventor: Andreas GÖBBELS, Kürten (DE)

(21) Appl. No.: 19/408,777

(22) Filed: Dec. 4, 2025

(30) Foreign Application Priority Data
Dec. 4, 2024 (DE) 10 2024 136 097.6

(51) Int. Cl. B60N 2/75

(52) U.S. Cl. CPC B60N 2/787

(57) ABSTRACT

An armrest arrangement with an armrest body connectable to a vehicle seat by a fastening device. The fastening device has a fastening receptacle on a seat side and a complementary fastening extension on the armrest body, and a locking system for releasable securing of the fastening extension in a fitted end position in which the fastening extension sinks into the fastening receptacle coaxially to a fitting axis. The fastening receptacle or the fastening extension has a locking body movably mounted radially to the fitting axis, the fastening extension or the fastening receptacle has a locking recess complementary to the locking body and into which the locking body can radially recede. An actuator is mounted for linear movement and is provided coaxially or axis-parallel to the fitting axis and is in operative connection to the locking body to move same into a locking or a release position. Use in passenger vehicles.

### CROSS-REFERENCE TO RELATED APPLICATION

This claims priority from German Application No. 102024136097.6, filed Dec. 4, 2024, the disclosure of which is hereby incorporated by reference in its entirety.

### TECHNICAL FIELD

The invention relates to an armrest arrangement for a vehicle seat, with an armrest body which is connectable to the vehicle seat by means of a fastening device, wherein the fastening device has a fastening receptacle on a seat side and a fastening extension complementary to the fastening receptacle on the armrest body, and with a locking system for releasable securing of the fastening extension inside the fastening receptacle in a fitted end position in which the fastening extension sinks into the fastening receptacle coaxially to a fitting axis. The invention also relates to a vehicle seat with such an armrest arrangement.

### BACKGROUND AND SUMMARY

A vehicle seat for a passenger vehicle is generally known. The vehicle seat has a seat surface as well as a backrest. Also, the vehicle seat is provided with at least one armrest arrangement having an armrest body. The armrest body is connectable to the vehicle seat by means of a fastening device. The fastening device comprises a fastening receptacle on the seat side and a fastening extension on the armrest body which is moved for its fitting into the fastening receptacle along a fitting axis and in a fitting direction. A locking system is used to secure the fastening extension in the fastening receptacle and permits release of the securing to enable the removal of the fastening extension from the fastening receptacle.

The purpose of the invention is to provide an armrest arrangement and a vehicle seat of the type mentioned at the outset that permit easy fitting and removal.

This object is achieved for the armrest arrangement in that the fastening receptacle or the fastening extension has at least one locking body movably mounted radially to the fitting axis, in that the fastening extension or the fastening receptacle has at least one locking recess complementary to the locking body and into which the locking body can radially sink, and in that an actuator mounted for linear movement is provided coaxially or axis-parallel to the fitting axis and is in operative connection to the at least one locking body in order to move the locking body into a locking position or into a release position. In the locking position, the locking body sinks radially into the locking recess. In the case of several locking bodies, all locking bodies can sink, depending on the embodiment, into the same locking recess or into a respective locking recess associated with each individual locking body. The locking body then protrudes, relative to an outer contour of the fastening extension or of the fastening receptacle, radially to the fitting axis and extends right into the locking recess. The locking body grips axially behind the fastening receptacle or the fastening extension and forms a positive connection between the fastening receptacle and the fastening extension. The fastening extension is thus secured on the fastening receptacle to prevent a movement opposite to the direction of fitting. To release the lock, the actuator is moved coaxially or axis-parallel to the fitting axis, whereby the locking body is moved from the locking position into the release position. In the release position, the locking body can withdraw out of the locking recess such that it no longer reaches into the locking recess. The locking system then permits a removal of the armrest body from the vehicle seat. In this way, a dependable and stable fastening of the armrest body to the vehicle seat is provided, wherein at the same time the armrest body can be detached from the vehicle seat. The actuator permits simple actuation of the locking system. If several locking bodies are provided, they can be at a distance from one another in the circumferential direction or in the direction of the fitting axis. Advantageously, the several locking bodies are arranged on one axial level.

The solution according to the invention is suitable in a particularly advantageous manner for wheeled vehicles in the form of buses, coaches, people carriers or vans. In the same way, the solution in accordance with the invention is usable in rail cars or in aircraft, advantageously in the passenger areas in each case, i.e. in the person transport field. The solution in accordance with the invention is usable particularly advantageously for minibuses, campers or motor homes. Use in the cabs of commercial vehicles is also contemplated, for example at construction sites or for cross country use. A vehicle seat provided with the armrest arrangement in accordance with the invention preferably has one armrest arrangement on each of the two sides of a seat area.

In one embodiment of the invention, the at least one locking body is designed spherical or cylindrical with rounded ends. The mounting of the locking body on the fastening receptacle or on the fastening extension is hence comparatively low-friction. In addition, skewing of the locking body during its radial movement is prevented. As a result, firstly the locking system is particularly easy to move, and secondly dependable actuation of the locking system is assured. Furthermore, the spherical locking bodies are comparatively sturdy, for example in comparison with pin-like locking bodies. The risk of destruction or damage of the locking bodies due to incorrect use of the armrest arrangement is thus minimized. The cylindrical locking bodies can transmit comparatively high forces between the fastening extension and the fastening receptacle, in particular in the direction of fitting. Each cylindrical locking body comprises two rounded ends and one cylindrical central section extending between them along a longitudinal axis. The central section has a preferably circular-cylindrical cross-section. The ends of the cylindrical locking bodies are designed in particular in the form of spherical segments, preferably hemispheres. As a result, the transition between a cylindrical central section of the cylindrical locking bodies and the rounded ends is smooth, in particular without edges.

In a further embodiment of the invention, the fastening extension and the fastening receptacle have rotationally unsymmetrical cross-sections complementary to one another, ensuring a rotation-proof axial fitting or removal relative to the fitting axis. “Rotationally unsymmetrical” means that the cross-section diverges from a circular shape. This prevents any rotation of the fastening extension relative to the fastening receptacle when the fastening extension has sunk far enough into the fastening receptacle. Also, the rotationally unsymmetrical and complementary cross-sections permit guidance of the fastening extension on the fastening receptacle during fitting or removal.

In a further embodiment of the invention, the fastening extension and the fastening receptacle have contours complementary to one another and steadily tapering in the direction of fitting. This reduces or prevents the risk of skewing of the fastening extension inside the fastening receptacle during fitting or removal. The fastening extension and the fastening receptacle may optionally also taper only over part of their length in the direction of fitting. The cross-section may optionally change continuously or gradually, or comprise a combination of the two.

In a further embodiment of the invention, the fastening extension or the fastening receptacle has several spherical receptacles distributed over the circumference for a corresponding number of spherical locking bodies or cylindrical locking bodies which are designed such that they permit a limited radial movability of the spherical locking bodies or the cylindrical locking bodies. The use of several locking bodies and their distribution over the circumference improve the dependability of the locking system. Advantageously, the spherical receptacles are arranged distributed over the circumference at equidistant intervals in order to uniformly secure the position of the fastening extension relative to the fastening receptacle. The cylindrical locking bodies are received in the spherical receptacles such that their respective longitudinal axes are aligned radially in relation to the fitting axis.

In a further embodiment of the invention, the fastening extension or the fastening receptacle has several slot-like receptacles, distributed over the circumference, for a corresponding number of cylindrical locking bodies which are designed such that they permit a limited radial movability of the cylindrical locking bodies. The cylindrical locking bodies are received in the receptacles such that their respective longitudinal axis is oriented, in particular parallel, to the fitting axis.

In a further embodiment of the invention, the spherical receptacles have a retaining function radially on the outside. The retaining function prevents any unintended movement of the locking bodies out of the spherical receptacles, for example during fitting or removal of the armrest arrangement. The retaining function is designed such that the locking bodies protrude in one part from the outside of the fastening extension in the locking position. In preferred embodiments, the spherical receptacles have a retaining ring radially on the outside, which is provided with openings, whose diameter is smaller than a diameter of the spherical locking bodies or of the cylindrical locking bodies, for a partial radial passage of these spherical locking bodies or cylindrical locking bodies. In the locking position, the spherical locking bodies or one end of the cylindrical locking bodies project with one spherical segment through the openings in the retaining ring and protrude with this part from the contour of the fastening extension. With the protruding part, the locking bodies sink into the locking recesses and are prevented from any further radial movement by the retaining ring. Alternatively to the retaining ring, individual retaining elements may also be provided for each of the spherical receptacles for restricting the movability of the locking bodies in the same way. The diameter of the cylindrical locking body is defined by the diameter of the cylindrical central section or by the diameter of the rounded end, depending on whether or not the end has a greater diameter than the cylindrical central section. The retaining function is provided in similar fashion for the slot-like receptacles in corresponding embodiments.

Alternatively to the retaining ring, it is provided in other advantageous embodiments that the spherical receptacles or the slot-like receptacles each have at least one plastic deformation radially on the outside, so that the deformation projects into a radial movement path of the locking body in the spherical receptacle. The material structure of the fastening extension enclosing a rim of the spherical receptacle is plastically shaped such that the shaped material structure extends into the opening. The locking body contacts the material structure in the locking position, which prevents a further outward radial movement of the locking body. Advantageously, each spherical receptacle is provided with several plastic deformations which are arranged distributed around the rim of the opening. For example, the rim area can, after insertion of a locking body into the spherical receptacle, be plastically shaped using a tool at one or more points distributed over the circumference of the opening.

In a further embodiment of the invention, the fastening receptacle has as locking recesses several axially extending channel sections, arranged distributed over a circumference of the fastening receptacle, which are provided with circular-arc-shaped channel cross-sections matching the diameter of the spherical locking bodies or the diameter of the cylindrical locking bodies, and which are provided with an axial stop at the axial level of a fitting position of the locking bodies. In the locking position, the locking bodies are seated in the substantially complementarily shaped channel sections. The channel sections thus contribute to a low-clearance or zero-clearance locking system. In the locking position, the locking bodies are in contact with the axial stop and thereby prevent an axial movement of the fastening extension. In the release position, the locking bodies can radially withdraw far enough to be not in contact with the respective axial stops when the fastening extension is removed from the fastening receptacle. If a locking body in the release position has not yet drawn back radially into the spherical receptacle or slot-like receptacles by itself, the axial stop acts as a guide for the locking body and during a movement of the fastening extension forces the latter, opposite to the direction of fitting, back into the respective spherical receptacle or slot-like receptacles.

In a further embodiment of the invention, the axial stop has a rounded longitudinal section shape, of which the radius in particular corresponds at least largely to a radius of a spherical locking body or to a radius of a spherical end of a cylindrical locking body. This further reduces a possible clearance of the locking bodies. Also, the radius assists the forcing of the locking bodies back into the spherical receptacles or slot-like receptacles and thereby facilitates the removal of the fastening extension.

In a further embodiment of the invention, the actuator is arranged in the fastening extension coaxially to a central longitudinal axis of the fastening extension, and the fastening device or the actuator has at the rear towards the direction of fitting a manually operable pushbutton element which is accessible from a rear face of the fastening extension in order to move the actuator. The pushbutton element is advantageously designed as a pressing element for pressing or as a pull element, for example as a mushroom head element, for pulling. The pushbutton element is integrally shaped on the actuator or is provided as a separate component. The coaxial arrangement of the actuator in the fastening extension permits in particularly simple manner a simultaneous movement of the optionally several locking elements distributed over the circumference between the locking position and the release position. Preferably, the spherical receptacles are in the form of passage openings in the fastening extension which open into the space in which the actuator is mounted in the fastening extension. Using the pushbutton element, the actuator is manually actuatable from a readily accessible place. In the end position of the fastening extension, the central longitudinal axis and the fitting axis are advantageously co-linear or at least axis-parallel, though this is not essential.

In a further embodiment of the invention, the actuator has at the axial level of the at least one locking body a radial lip which forces the locking body radially outwards depending on a linear movement of the actuator. In the region of the radial lip, the actuator has a greater radius than in an axis section axially adjoining it. In the locking position of the locking body, the actuator takes up an axial position inside the fastening extension, in which the radial lip is arranged radially inside the locking bodies and forces the latter radially outwards into the spherical receptacles or slot-like receptacles. In order to move the locking bodies into the release position, the actuator is moved along the fitting axis inside the fastening extension until the adjoining axis section is radially arranged inside the locking bodies. Due to the smaller radius, the actuator permits a radially inward movement of the locking bodies. The locking bodies can thus radially withdraw into the spherical receptacles or slot-like receptacles in the release position. In this way the actuator interacts directly with the locking bodies in order to move them between the locking position and the release position.

In a further embodiment of the invention, the actuator is designed as a piston rod and the radial lip is formed by an annular shoulder projecting radially outwards at a front end of the piston rod. The radial lip is thus very simple to manufacture. In particularly advantageous embodiments, the actuator forms, with the front end of the piston rod opposite to the annular shoulder, the manually operable pushbutton element. With the pushbutton element designed as a pressing element, the piston rod is moved along the direction of fitting by a pressing movement on the pressing element, and the annular shoulder disengages from the locking bodies.

In other embodiments, the annular shoulder is formed in an axial end region of the piston rod which is axially at a distance from the front end. The piston rod has a smaller radius than the annular shoulder in an axis section adjoining the annular shoulder and the front end. With the pushbutton element designed as a pull element, the piston rod is moved opposite to the direction of fitting by a pulling movement on the pull element, and the annular shoulder is disengaged from the locking bodies.

In a further embodiment of the invention, the annular shoulder has an outer contour conically tapering from the front end of the piston rod towards the pushbutton element or from the pushbutton element towards the front end. As a result, the annular shoulder continuously forces the locking bodies into the locking recesses in the fastening receptacle during movement of the actuator. This reduces the risk of jamming of the locking bodies during movement from the release position into the locking position.

In a further embodiment of the invention, the actuator has in the axial direction a parabolic contour between the radial lip and an adjoining section of the actuator. The parabolic contour effects a smooth and hence gentle forcing of the locking bodies back into the locking recesses when the actuator is actuated. Furthermore, this contour effects a compensation for the production tolerances of the actuator.

In a further embodiment of the invention, the pushbutton element has a first and/or second guide section which is operatively connected to a complementary first and/or second guide section arranged on the actuator and/or on the fastening extension, in order to hold the pushbutton element in an axially movable manner on the actuator and/or on the fastening extension, and the pushbutton element is braced against the actuator by means of a compensating spring. Due to the fact that the pushbutton element is provided separately from the actuator and is braced against the actuator by the compensating spring, a tolerance compensation for the actuator is provided in the direction of the central longitudinal axis of the fastening extension. Using the pushbutton element, compressive forces can be transmitted to the actuator to actuate it. The compensating spring resets the pushbutton element into a rest position after an actuation. If the actuator has a complementary first guide section, the pushbutton element is indicative for the position of the actuator. Since the pushbutton element is discernible for a user from outside the fastening extension, the user can deduce the position of the actuator from the position of the pushbutton element. If the fastening extension has a complementary second guide section, an end position relative to the fastening extension is defined for the pushbutton element and hence also indirectly for the actuator. The pushbutton element then does not protrude further beyond the fastening extension than determined by the end position. This permits a flush design with the outside of the armrest. Furthermore, the pushbutton element and the actuator are then secured on the fastening extension. If both the complementary first guide section on n the actuator and also the complementary second guide section on the fastening extension are provided, the actuator can additionally be rotation-proof relative to the fastening extension.

In a further embodiment of the invention, the actuator has several axially extending channel sections arranged distributed over the circumference and provided with circular-arc-shaped channel cross-sections matched to the diameters of the spherical locking bodies or of the cylindrical locking bodies. The result is a line contact between the locking bodies and the actuator. The fastening device can thus absorb greater forces in the direction transverse to the fitting axis and transverse to the central longitudinal axis of the fastening extension. In the event that only a single locking body is provided, it is received in a single channel section.

In a further embodiment of the invention, the actuator is permanently axially loaded in or opposite to the direction of fitting by a resetting spring which is arranged in the fastening extension. The resetting spring resets the actuator automatically into the initial position after an actuation using the pushbutton element. Also, the resetting spring prevents the actuator from moving by itself in an unintended manner along the central longitudinal axis of the fastening extension and as a result permitting in an unintended manner a movement of the locking bodies from the locking position into the release position. Depending on whether the pushbutton element is designed as a pressing element or as a pull element, the actuator is reset opposite to the direction of fitting or in the direction of fitting.

In a further embodiment of the invention, a releasable engagement device is provided which secures the actuator in an engaged position when the locking bodies are moved into the release position. The engagement device secures the actuator in the actuated position. This avoids the need for the actuator to be continuously actuated in order to leave the locking bodies in the release position so that the fastening extension can be arranged in the fastening receptacle in the fitted end position. Instead, it is possible to actuate the actuator once, thereby moving the locking bodies into the release position and engaging them in the actuated position. The fastening extension can also then sink into the fastening receptacle without further actuation of the actuator, and without the locking bodies colliding with the fastening receptacle. As soon as the fastening extension is arranged in the fitted end position, the engagement device is released, so that the resetting spring resets the actuator into its initial position in which the actuator moves the locking bodies into the locking position. The fastening extension is then locked to the fastening receptacle. Preferably, the engagement device comprises an axially protruding engagement extension at the front end of the actuator which, when the actuator is actuated, projects through an end face opening in the fastening extension along the central longitudinal axis and in this position engages with the fastening extension. When the engagement is released, the actuator is pushed back axially inside the fastening extension, opposite to the direction of fitting, and the engagement extension is received in the interior of the fastening extension. Particularly preferably, the engagement device also comprises an engagement stop on the fastening receptacle side, against which the engagement extension comes into contact in the fitted end position of the fastening extension, whereby the engagement of the engagement extension with the fastening extension is automatically released.

In a further embodiment of the invention, the engagement device has an engagement element which in the engaged position engages the actuator with the fastening extension and which releases the engagement of the actuator upon contact with the engagement stop of the fastening receptacle. The engagement force is settable by the selection of the engagement element. The engagement element can also be replaced if required. The engagement element is in particular firmly connected to the fastening extension and designed for engagement with a complementary engagement section of the actuator, or conversely. Preferably, the engagement element is designed as a clasp or clip, particularly preferably of metal or steel. If an engagement element is provided which is arranged rotationally unsymmetrical in relation to the actuator, it is an advantage if the actuator is received rotation-proof inside the fastening extension.

In a further embodiment of the invention, the resetting spring is designed as a compression spring which exerts on the front end of the piston rod an axial compressive force which is less than a manually appliable and opposite-direction compressive force on the pushbutton element of the actuator. This arrangement of the compression spring represents a particularly simple implementation of the resetting spring. In designs with a pull element as the pushbutton element, the resetting spring is preferably designed as a tension spring. If the pushbutton element is designed as a pull element, a loading direction of the compression spring may also be reversed such that it continues to act opposite to the pull direction as a compression spring.

For the vehicle seat, the object underlying the invention is achieved in that the vehicle seat is provided with at least one armrest arrangement as previously described.

### BRIEF DESCRIPTION OF THE DRAWINGS

Further advantages and features of the invention are revealed by the claims and by the following description of preferred examples of the invention which are explained with reference to the drawings.

FIG. 1 shows in perspective part of an embodiment of an armrest arrangement in accordance with the invention with an armrest body and a fastening extension,

FIG. 2 in perspective a partial area of an embodiment of a vehicle seat in accordance with the invention with the armrest arrangement according to FIG. 1,

FIG. 3 in an exploded view a fastening device of the armrest arrangement according to FIG. 1,

FIG. 4 in a schematic longitudinal section the fastening device of the armrest arrangement according to FIGS. 1 and 3 with a locking body in the locking position,

FIGS. 5 and 6 in a schematic longitudinal section part of the fastening device of the armrest arrangement according to FIGS. 1 and 3 with the locking body in the locking position and in the release position,

FIG. 7 in a schematic longitudinal section a fastening device of a further embodiment of an armrest arrangement in accordance with the invention,

FIG. 8 in an enlarged view an area A in FIG. 7,

FIG. 9 in a schematic side view a partial area of a fastening extension of a further embodiment of an armrest arrangement in accordance with the invention,

FIG. 10 in perspective a fastening extension of a further embodiment of an armrest arrangement in accordance with the invention,

FIG. 11 in a schematic longitudinal section a fastening device of the armrest arrangement according to FIG. 10 with a locking body in the locking position,

FIG. 12 in a schematic longitudinal section the fastening device according to FIG. 11 with a locking body in the release position, and

FIG. 13 in perspective a section of the fastening extension according to FIGS. 10 to 12.

### DETAILED DESCRIPTION

A vehicle seat, not shown in detail, is provided for a passenger vehicle in the form of a people carrier, a van or a minibus. The vehicle seat has a seat surface adjoined at the rear by a backrest 2, shown only partially. The backrest 2 and the seat surface are arranged stationary and optionally adjustable inside the passenger vehicle. The backrest 2 has at each opposite side a side plate on which an armrest arrangement 10 is arranged. As shown in FIG. 2, only the left-hand side plate of the backrest 2 is provided with an armrest arrangement 10. However, the opposite, right-hand side plate of the backrest 2 can be provided in the same way with a mirror-symmetrical but otherwise identical armrest arrangement 10.

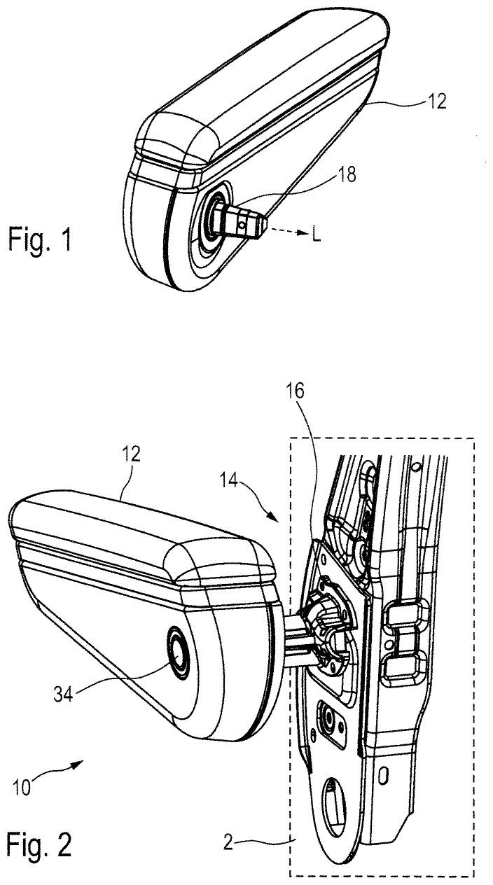

In an example, not shown, of the invention, the armrest arrangement 10 is arranged not in the region of side plates of the backrest, but instead in the region of a supporting structure area for the seat surface. The basic design and also the basic function of such an armrest arrangement do not however differ from the armrest arrangement 10 according to FIGS. 1 to 13.

The armrest arrangement 10 according to FIGS. 1 to 6 has an armrest body 12 which is connectable to the vehicle seat by means of a fastening device 14. The fastening device 14 comprises a fastening receptacle 16 which is fastened to the vehicle seat in the region of a supporting structure section of the side plate of the backrest 2. The fastening device 14 also comprises a fastening extension 18 complementary to the fastening receptacle 16 and in turn connected to the armrest body 12, as shown in FIG. 1. For fitting, the fastening extension 18 is moved along a fitting axis M in the direction of fitting, i.e. in the direction of the fastening receptacle 16, until it sinks into the fastening receptacle 16. In an end position of the fastening extension 18 inside the fastening receptacle 16, a locking system secures the fastening extension 18 against falling out or being removed from the fastening receptacle 16.

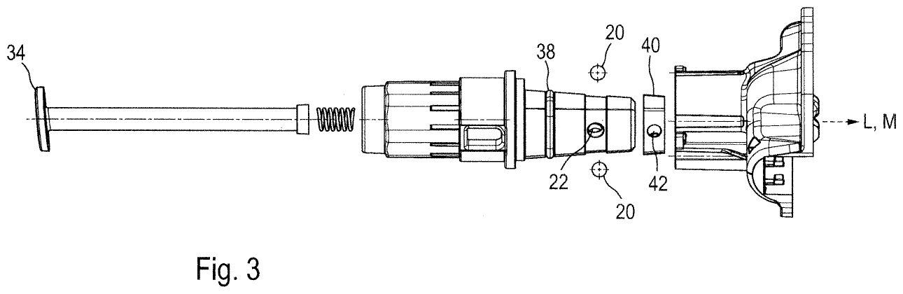

For implementation of the locking system, several spherical locking bodies 20 are provided which are arranged on the fastening extension 18 at equidistant intervals in the circumferential direction, as may be seen when FIGS. 1 and 3 are viewed together. The locking bodies 20 are mounted movably, in associated spherical receptacles 22 of the fastening extension 18, radially to the fitting axis M, between a locking position and a release position. In the release position, the locking bodies 20 are completely received in the spherical receptacles 22 so that they do not protrude beyond an outer contour of the fastening extension 18, or are at least prevented from withdrawing into the spherical receptacles 22. In the release position, the fastening extension 18 can readily be moved out of and into the fastening receptacle 16. In the locking position, the locking bodies 20 are forced outwards radially to the fitting axis M, such that they project in some sections, i.e. with a spherical segment, beyond the outer contour of the fastening extension 18. With the protruding section, the locking bodies 20 interact with the fastening receptacle 16 and prevent in this way any movement of the fastening extension 18 out of the fastening receptacle 16 and along the fitting axis M.

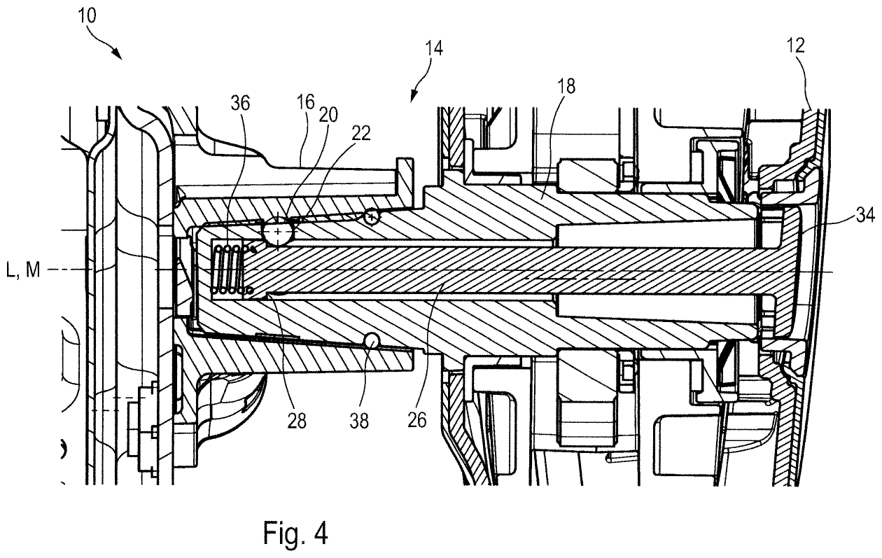

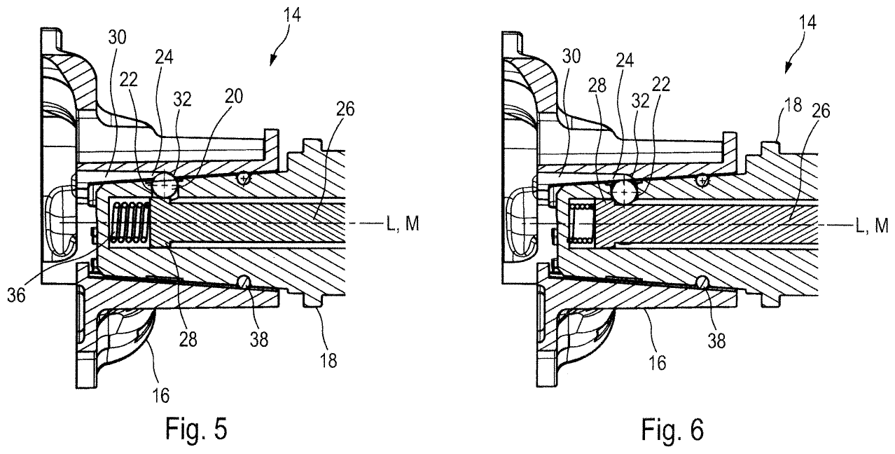

Specifically, the fastening receptacle 16 has a locking recess 24 complementary to the locking body 20 and with which the locking body 20 interacts for locking. As may be seen in FIGS. 4 and 5, the locking body 20 is, in the locking position, arranged in the locking recess 24 with the section projecting beyond the outer contour of the fastening extension 18, and grips behind the fastening receptacle 16 in relation to the fitting axis M in the axial direction. In this way, the locking bodies 20 prevent an axial movement of the fastening extension 18. The locking system is formed by a positive connection of the locking bodies 20 and the associated locking recesses 24.

### In the Interior of the Fastening Extension 18, an

actuator 26 is arranged which is mounted along a central longitudinal axis L of the fastening extension 18, as shown in FIGS. 3 to 6. The actuator 26 has at its one end, which in the fitted end position is facing the fastening receptacle 16, a radial lip 28 which forces the locking bodies 20 into the locking recesses 24 in the locking position radially to the fitting axis M and to the central longitudinal axis L, as shown in FIG. 5. To release the lock, the actuator 26 is moved inside the fastening extension 18 along the central longitudinal axis L, until the radial lip 28 has moved out axially past the spherical receptacle 22 and can no longer come into contact with the locking bodies 20. In an axis section adjoining the radial lip 28, the actuator 26 has a smaller radius and thus permits a radial withdrawal of the locking body 20 into the spherical receptacles 22. If the locking body 20 is arranged above the central longitudinal axis L, the locking body 20 drops, due to gravity, back into the space inside the spherical receptacle 22 exposed by the actuator 26.

In the case of several locking bodies 20 arranged distributed over the circumference of the fastening extension 18, the locking bodies 20 arranged above the central longitudinal axis L in the spherical receptacles 22 drop down, i.e. radially inwards, in the release position. The locking bodies 20 arranged below the central longitudinal axis L initially remain in the position in which they were in the locking position too and in which they extend into the locking recesses 24. As soon as the fastening extension 18 is moved out along the fitting axis M and out of the fastening receptacle 16, these locking bodies 20 are forced back into the spherical receptacles 22 upon axial contact with the fastening receptacle 16. The locking bodies 20 thus do not prevent the axial movement of the fastening extension 18 in the release position, even if they protrude from the outer contour of the fastening extension 18. The fastening extension 18 is then not secured in the end position by the locking system.

The locking recesses 24 are in the form of channel sections 30, as shown in FIGS. 5 and 6. The channel sections 30 extend parallel to the fitting axis M and have circular-arc-shaped channel cross-sections matching the diameters of the spherical locking bodies 20. This fixes a position of the locking bodies 20 inside the locking recesses 24 in the circumferential direction. The channel sections 30 end in the axial direction in an axial stop 32 at an end facing the fastening extension 18. In the locking position, the spherical locking bodies 20 come into contact with the respective axial stops 32, whereby the locking of the fastening extension 18 to the fastening receptacle 16 is achieved. The axial stops 32 have a rounded longitudinal section shape, the radius of which substantially matches a radius of the locking bodies 20. In the release position, the longitudinal section shape of the axial stop 32 assists the forcing of the locking bodies 20 back into the spherical receptacles 22 during movement of the fastening extension 18 opposite to the direction of fitting.

The actuator 26 is designed as a piston rod and has, at the end facing away from the fastening receptacle 16, a pushbutton element 34 in the form of a pressing element as shown in FIGS. 3 and 4. By manual pressing of the pushbutton element 34, the actuator 26 is moved coaxially to the central longitudinal axis L in the direction of the fastening receptacle 16 and permits the withdrawal of the locking elements 20 into the spherical receptacles 22 and hence the removal of the fastening extension 18 from the fastening receptacle 16 or its insertion into the fastening receptacle 16. The pushbutton element 34 can therefore be actuated for example by a side of the armrest body 12 facing away from the fastening device 14, as shown in FIG. 2. As soon as the pushbutton element 34 is no longer actuated, a resetting spring 36 designed as a compression spring sets the actuator 26 back into the initial position, in which the radial lip 28 forces the locking bodies 20 radially outwards into the spherical receptacles 22. Due to the locking bodies 20 protruding from the outer contour of the fastening extension 18, they would collide with the fastening receptacle 16 if an attempt were to be made to move the fastening extension into the end position in the fastening receptacle 16. For that reason, if the actuator 26 is not actuated the fastening extension 18 cannot completely sink into the fastening receptacle 16. Actuation of the actuator 26 is thus not required for fitting. The resetting spring 36 abuts at the one side the radial lip 28 on that side facing away from the actuator 26, and on the other side an inner side of the fastening extension 18.

The radial lip 28 is designed as an annular shoulder projecting outwards at the front end of the piston rod. As can be seen for example in FIG. 3, the annular shoulder has an outer contour conically tapering from the front end of the piston rod towards the pushbutton element 34. The result of this is that the locking bodies 20 are forced continuously outwards upon contact with the annular shoulder when the actuator 26 inside the fastening extension 18 is withdrawn. The resetting spring 36 exerts on the front end of the piston rod an axial compressive force that has to be overcome to enable linear movement of the actuator 26.

The fastening extension 18 has a contour tapering along the fitting axis M, as shown in FIG. 1. The fastening extension 18 also has a non-circular cross-section which is designed substantially in the form of a triangle with flattened corners. The fastening receptacle 16 is designed complementary to the fastening extension 18. The complementarily designed outer contours of the fastening extension 18 and of the fastening receptacle 16 represent an axial guide for the fastening extension 18 and prevent a relative rotation.

An all-round sealing ring 38 is arranged on the fastening extension 18 at an axial distance from the locking bodies 20. In the end position of the fastening extension 18, the sealing ring 38 additionally braces the latter against the fastening receptacle 16 and reduces any clearance. Also, the sealing ring 38 can prevent any unintended slipping of the fastening extension 18 out of the fastening receptacle 16 when the lock is released.

The fastening device 14 furthermore has a retaining function in the form of a retaining ring 40 which is provided on the fastening extension 18 radially outside the spherical receptacles 22. The retaining ring 30 prevents any unintended dropping of the locking bodies 20 out of the spherical receptacles 22. The retaining ring 40 is provided with one opening 42 each to permit the locking bodies 20 to protrude out of the spherical receptacles 22. For that purpose, the openings 42 each have a diameter smaller than the diameter of an associated spherical locking body 20.

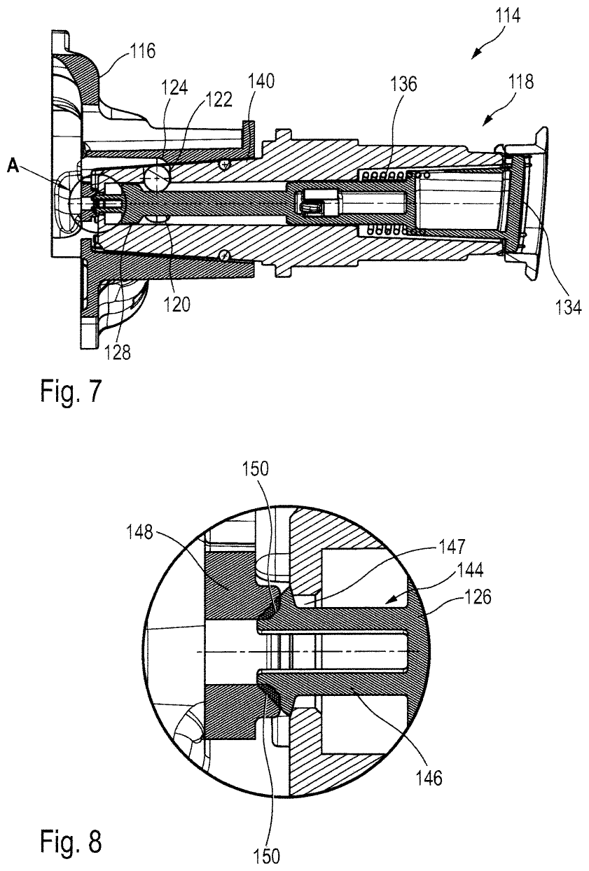

FIGS. 7 and 8 show a further embodiment of the armrest arrangement in accordance with the invention. An armrest arrangement comprises a fastening device 114 with a fastening receptacle 116 and with a fastening extension 118 in which an actuator 126 in the form of a piston rod is mounted in axially and longitudinally movable manner. The armrest arrangement has the same mode of operation as the armrest arrangement 10 according to FIGS. 1 to 6, unless otherwise described here.

The actuator 126 has at its end a pushbutton element 134 in the form of a pressing element. At an end opposite to the pushbutton element 134, an engagement extension 144 comprising several engagement arms 146 is provided. FIGS. 7 and 8 show two of the engagement arms 146. The fastening extension 118 is provided with a front end opening 147 into which the engagement extension 144 extends when the actuator 126 is moved into an engaged position in which the actuator 126 inside the fastening extension 118 is pushed axially forward. In the engaged position, a radial lip 128 designed as an annular shoulder is disengaged from several locking bodies 120, such that the locking bodies 120 can radially withdraw into associated spherical receptacles 122. A retaining ring 140 secures the locking bodies 120 in the spherical receptacles 122. In the engaged position, the engagement arms 146 extend through the front end opening 147 in the fastening extension 118 and, in the axial direction, grip behind the front end area, surrounding the front end opening 147, of the fastening extension 118, as shown in FIG. 8 in the enlarged view of area A. A resetting spring 136 pretensions the actuator 126 into its initial position opposite to the direction of fitting and thus presses the engagement arms 146 against the front end area. As a result, the actuator 126 engages with the engagement extension 144 on the fastening extension 118, so that an axial movement of the actuator 126 away from the front end of the fastening extension 118 is prevented. In this way, the actuator 126 is fixed in the engaged position and the fastening extension 118 can be moved without problem along the fitting axis M into and out of the fastening receptacle 116, without the locking bodies 120 preventing this movement.

In a front end region of the fastening receptacle 116 facing the front end of the fastening extension 118, an engagement stop 148 is provided which is designed complementary to the engagement extension 144 and interacts with it to release the engagement of the engagement extension 144 with the fastening extension 118. The engagement stop 148 comprises one or more oblique stop surfaces 150, associated with the engagement arms 146, which press the engagement arms 146 radially inwards during an axial movement of the engagement extension 144, so that the engagement arms 146 can be moved through the front end opening 147 in the fastening extension 118. The actuator 126 can then be moved in the fastening extension 118 along the central longitudinal axis L until the radial lip 128 engages with the locking bodies 120 and forces them radially outwards into the spherical receptacles 122. The engagement extension 144 engaged with the front end region of the fastening extension 118 interacts with the engagement stop 148 to release the engagement only when the fastening extension 118 reaches its fitted end position in the fastening receptacle 116. The resetting spring 136 then automatically resets the actuator 126 into its initial position, in which the engagement extension 144 not longer extends through the front end opening 147.

This embodiment permits fitting and automatic locking of the fastening extension 118 in the fastening receptacle 116 without the need for the user to hold the actuator 126 continuously in the axially forward position at the same time.

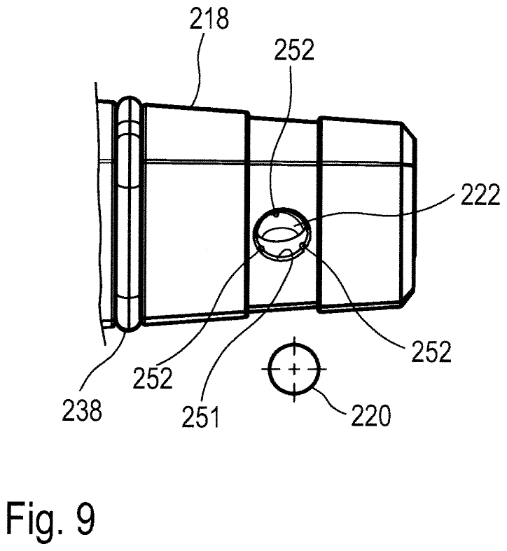

FIG. 9 shows a third embodiment of an armrest arrangement in accordance with the invention. Specifically, FIG. 9 shows a partial area, facing a fastening receptacle, of a fastening extension 208 of an armrest arrangement. The fastening extension 208 comprises several locking bodies 220 received in associated spherical receptacles 222. The spherical receptacles 222 each have a receptacle opening 251 radially outside. Instead of the retaining ring 40 in the armrest arrangement according to FIGS. 1 to 6, the retaining function in the armrest arrangement according to FIG. 9 is provided in each case by three deformations 252. Each of the deformations 252 is made by working on the material of the fastening extension 208 in such a way that the material protrudes radially inwards in relation to the receptacle opening 251 from the rim of the receptacle opening 251. The deformation 252 is arranged in a movement path of the locking body 220 received in the spherical receptacle 222, and blocks the receptacle opening 251 such that the locking body 220 cannot readily be moved out of the spherical receptacle 222. The three deformations 252 are arranged distributed over the rim of the receptacle opening 251 at equidistant intervals.

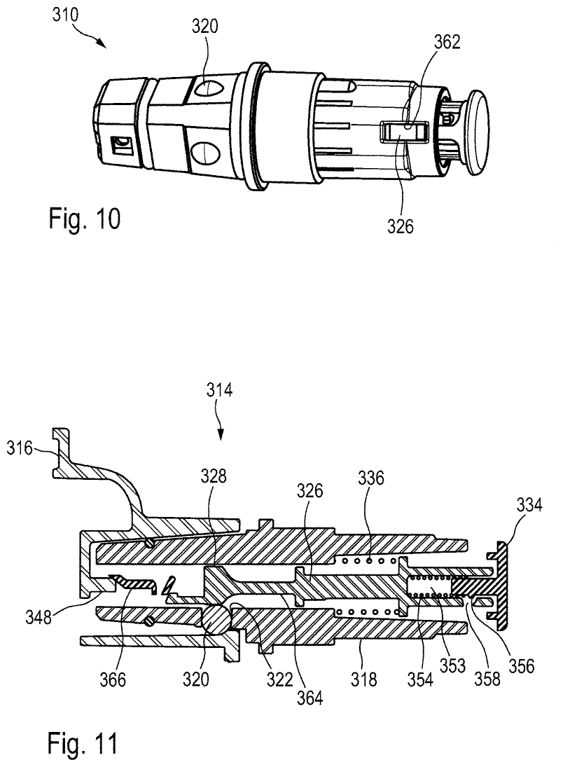

FIGS. 10 to 13 show a further embodiment of an armrest arrangement in accordance with the invention. The armrest arrangement comprises a fastening device 314 with a fastening receptacle 316 and with a fastening extension 318 inside which an actuator 326 in the form of a piston rod is mounted in axially and longitudinally movable manner. The armrest arrangement has the same mode of operation as the armrest arrangements 10 according to FIGS. 1 to 6 and 7 and 8, unless otherwise described here.

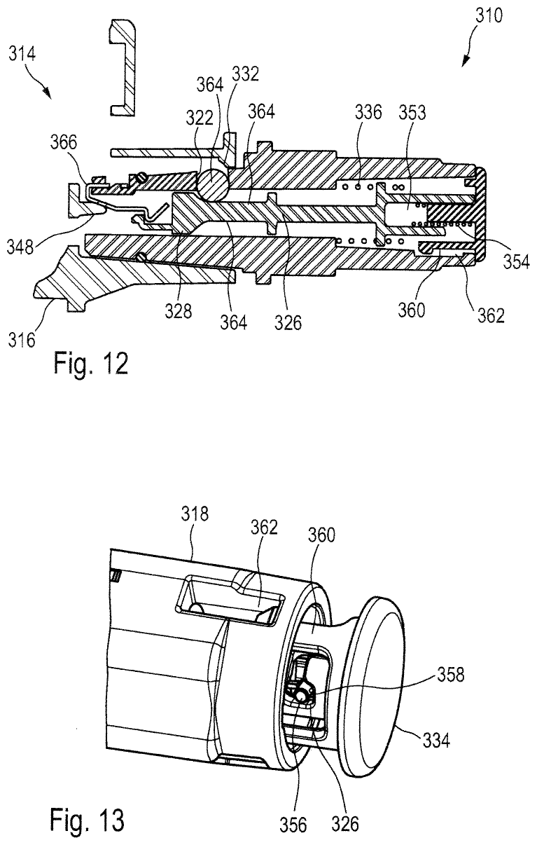

In addition to the actuator 326, the fastening device 324 has a separate pushbutton element 334. The pushbutton element 334 is designed T-shaped in cross-section and for pressed actuation on the one side, and with the other side engages along the central longitudinal axis L with an axial receptacle section 353 of the actuator 326, as shown in FIGS. 11 and 12. Inside the receptacle section 353, a compensating spring 354 is arranged by which the pushbutton element 334 is axially braced against the actuator 326.

At that part of the pushbutton element 334 which engages in the receptacle section 353, a first guide section 356 in the form of a radially protruding pin is integrally molded on the circumference side, see FIGS. 10 and 13. The first guide section 356 engages radially in a slot-like complementary first guide section 358 formed on the actuator 326 along the receptacle section 353. The interaction of the first guide section 356 and the complementary first guide section 358 permits an axially guided movement of the pushbutton element 334 relative to the actuator 326. At the same time, the pushbutton element 334 is held on the actuator 326 by the first guide sections 356, 358. After an actuation, the compensating spring 354 resets the pushbutton element 334 into a rest position in the direction out of the receptacle section 353. In the rest position, the first guide section 356 is in contact with a rim contour of the complementary first guide section 358.

As indicated in FIG. 13, the complementary first guide section 358 is open to the outside via a rectangular and slot-like recess in the axial direction. Via the rectangular recess, the first guide section 356 can be inserted into the complementary first guide section 358 by a combined axial and rotary movement. The pushbutton element 334 is then detachably held by on the actuator 326 by means of a bayonet lock.

Several second guide sections 360 in the form of axially extending ribs are integrally molded on that part of the pushbutton element 334 which is designed for pressing actuation. The several second guide sections 360 are arranged distributed in the circumferential direction. The second guide sections 360 extend axially between the actuator 326 and the fastening extension 318 parallel to the central longitudinal axis L. The second guide sections 360 engage in the manner of a snap connection with complementary second guide sections 362 on the fastening extension, see FIGS. 10, 12 and 13. The second guide sections 360 can be bent radially inwards to permit their removal from the complementary second guide sections. Using the second guide sections 360, 362, the pushbutton element 334 on the fastening extension 318 is guided in axially movable manner and held detachably.

The spherical locking bodies 320 are each mounted in associated channel sections 364 that extend along the actuator 326. The channel sections 364 have circular-arc-shaped channel cross-sections whose radius is matched to the radius of the locking bodies 320. This can be seen from FIG. 12, which shows two channel sections 364 radially opposite to one another, wherein the longitudinal section extends at different levels along the channel walls. The locking bodies 320 are in contact with the actuator 326 along lines oriented transversely to the central longitudinal axis L.

The channel sections 364 end at the front end in a radial lip 328. The channel sections 364 each merge into the radial lip 328 along a parabolic contour. This has the effect that during axial movement of the actuator 326, the locking bodies 320 are forced back continuously and at variable speed into the spherical receptacles 322, and conversely in the opposite direction.

Instead of the engagement arms 146 in the embodiment according to FIGS. 7 and 8, an engagement element in the form of a clip 366 is provided in the embodiment according to FIGS. 10 to 13. The clip 366 is fastened at one end to the fastening extension 318 and with a central section extends axially into the fastening extension 318 at the front end. At the other end, the clip 366 has an engagement lug which is detachably engageable behind a complementary engagement lug which is integrally molded to the actuator 326, as shown in FIG. 12. The clip 366 is made of steel and is elastically shapeable.

When the pushbutton element 334 is actuated, the pushbutton element 334 presses against the actuator 326 and moves it axially along the fitting axis M until the engagement lug of the clip 366 grips behind the complementary engagement lug of the actuator 326, see FIG. 12. The actuator 326 is then engaged with the fastening extension 318 in this position. In this position of the actuator 326, a radially inward movement of the locking bodies 320 is enabled. As a result, the fastening extension 318 can be moved freely into the fastening receptacle 316 or out of the fastening receptacle 316.

In the fastening receptacle 316, an engagement stop 348 is formed which, when the fastening extension 318 sinks completely into the fastening receptacle 316, presses against the central section of the clip 366. The engagement stop 348 effects a radial lifting of the clip 366 and thereby releases the engagement of the clip 366 with the actuator 326. A resetting spring 336 arranged in the fastening extension 318 moves the actuator 326 in the direction of the pushbutton element 334. At the same time the locking bodies 320 slide along the channel sections 364 and are steadily forced along the parabolic contour back into the spherical receptacles 322. In the end position of the actuator 326, the radial lip 328 is at the axial level of the locking bodies 320, and forces the locking bodies 320 in the spherical receptacles 322 so far back that the locking bodies 320 protrude radially from the fastening extension 318, see FIG. 11. The locking bodies 320 are then in the locking position.

In an embodiment not shown, the locking bodies are provided at the fastening receptacle and in the locking position engage in a respectively associated locking recess of the fastening extension. To force the locking bodies radially in the direction of the locking recesses, it is in particular possible to provide an actuator mounted axis-parallel to the fitting axis for linear movement.

1. An armrest arrangement for a vehicle seat, with an armrest body which is connectable to the vehicle seat by means of a fastening device, wherein the fastening device has a fastening receptacle on a seat side and a fastening extension complementary to the fastening receptacle on the armrest body, and with a locking system for releasable securing of the fastening extension inside the fastening receptacle in a fitted end position in which the fastening extension sinks into the fastening receptacle coaxially to a fitting axis, wherein the fastening receptacle or the fastening extension has at least one locking body movably mounted radially to the fitting axis, in that the fastening extension or the fastening receptacle has at least one locking recess complementary to the locking body and into which the locking body can radially sink, and in that an actuator mounted for linear movement is provided coaxially or axis-parallel to the fitting axis and is in operative connection to the at least one locking body in order to move the locking body into a locking position or into a release position.

2. The armrest arrangement according to claim 1, wherein the at least one locking body is designed spherical or cylindrical with rounded ends.

3. The armrest arrangement according to claim 1, wherein the fastening extension and the fastening receptacle have rotationally unsymmetrical cross-sections complementary to one another, which ensure a rotation-proof axial fitting or removal relative to the fitting axis.

4. The armrest arrangement according to claim 3, wherein the fastening extension and the fastening receptacle have complementary contours steadily tapering in the direction of fitting.

5. The armrest arrangement according to claim 1, wherein in that the fastening extension has several spherical receptacles distributed over its circumference for a corresponding number of spherical locking bodies or cylindrical locking bodies which are configured such that they permit a limited radial movability of the spherical locking bodies or of the cylindrical locking bodies.

6. The armrest arrangement according to claim 5, wherein the spherical receptacles have a retaining function radially on the outside, in particular a retaining ring, which is provided with openings for a partial radial passage of the spherical locking bodies or cylindrical locking bodies, whose diameter is smaller than a diameter of the spherical locking bodies or cylindrical locking bodies, or in each case at least one plastic deformation, so that the deformation projects into a radial movement path of the locking body in the spherical receptacle.

7. The armrest arrangement according to claim 1, wherein the fastening receptacle has as locking recesses several axially extending channel sections, arranged distributed over a circumference of the fastening receptacle, which are provided with circular-arc-shaped channel cross-sections matching the diameter of the spherical locking bodies or the diameter of the cylindrical locking bodies, and which are provided with an axial stop at the axial level of a fitting position of the locking bodies.

8. The armrest arrangement according to claim 7, wherein the axial stop has a rounded longitudinal section shape, of which the radius in particular corresponds at least largely to a radius of a spherical locking body or to a radius of a spherical end of a cylindrical locking body.

9. The armrest arrangement according to claim 1, wherein the actuator is arranged in the fastening extension coaxially to a central longitudinal axis of the fastening extension, and the fastening device or the actuator has at the rear towards the direction of fitting a manually operable pushbutton element which is accessible from a rear face of the fastening extension in order to move the actuator.

10. The armrest arrangement according to claim 9, wherein the actuator has at the axial level of the at least one locking body a radial lip which forces the locking body radially outwards depending on a linear movement of the actuator.

11. The armrest arrangement according to claim 9, wherein the actuator is configured as a piston rod, and in that the radial lip is formed by an annular shoulder projecting radially outwards at a front end, or in an axial end area, of the piston rod at an axial distance from the front end.

12. The armrest arrangement according to claim 11, wherein the annular shoulder has an outer contour conically tapering from the front end of the piston rod towards the pushbutton element or from the pushbutton element towards the front end.

13. The armrest arrangement according to claim 11, wherein the actuator has in the axial direction a parabolic contour between the radial lip and an adjoining section of the actuator.

14. The armrest arrangement according to claim 9, wherein in that the pushbutton element has a first and/or second guide section which is operatively connected to a complementary first and/or second guide section arranged on the actuator and/or on the fastening extension, in order to hold the pushbutton element in an axially movable manner on the actuator and/or on the fastening extension, and in that the pushbutton element is braced against the actuator by means of a compensating spring.

15. The armrest arrangement according to claim 1, wherein the actuator has several axially extending channel sections arranged distributed over the circumference and provided with circular-arc-shaped channel cross-sections matched to the diameters of the spherical locking bodies or of the cylindrical locking bodies.

16. The armrest arrangement according to claim 1, wherein the actuator is permanently axially loaded in or opposite to the direction of fitting by a resetting spring which is arranged in the fastening extension.

17. The armrest arrangement according to claim 16, wherein a releasable engagement device is provided which secures the actuator in an engaged position when the locking bodies are moved into the release position.

18. The armrest arrangement according to claim 17, wherein the engagement device has an engagement element which in the engaged position engages the actuator with the fastening extension and which releases the engagement of the actuator upon contact with an engagement stop of the fastening receptacle.

19. A vehicle seat with an armrest arrangement according to claim 1.
